(19) United States
(12) Patent Application Publication
(10) Pub. No.: US 2010/0156711 A1
(43) Pub. Date: Jun. 24, 2010

(54) TRAVEL TRACKING APPARATUS

(75) Inventors: Thomas CHRISTENSEN, Edmonton (CA); Curtis CLEMENTS, Port Coquitlam (CA)

Correspondence Address: DAVIS & BUJOLD, P.L.L.C., 112 PLEASANT STREET, CONCORD, NH, 03301, US

(73) Assignee: AUTOLOG INC., Edmonton (CA)

(21) Appl. No.: 12/640,407

(22) Filed: Dec. 17, 2009

(30) Foreign Application Priority Data
Dec. 17, 2008 (CA) 2647413

(51) Int. Cl. G01S 19/24

(52) U.S. Cl. 342/357.07

(57) ABSTRACT

A business travel tracking apparatus which includes a processor having a processor memory and a global positioning system sensor for determining vehicle position. An input device is provided which is in communication with the processor for designating each trip as either a business trip or a personal trip. A sensor is in communication with the processor for determining a commencement of the trip. An alarm is in communication with the processor. The processor activates the alarm when the trip sensor senses the commencement of a trip and deactivates the alarm when the input device indicates that a selection has been made.

### FIELD

The present invention relates to an apparatus that is used to track business or personal travel.

### BACKGROUND

There is a need for a business travel tracking apparatus that provides an audit trail acceptable to government agencies or employers to establish a deduction, or a taxable benefit, or for other purposes. An example of a system that is superior to many existing systems is U.S. Pat. No. 6,741,933 (Glass).

### SUMMARY

There is provided a travel tracking apparatus which includes a processor having a processor memory and a global positioning system sensor for determining vehicle position. The global positioning system sensor communicates geographic location data to the processor that allows the processor to record a trip including a starting point, points at periodic intervals along a travel route, and a destination. With this information the processor is able to calculate mileage. All of the foregoing information is stored in processor memory. An input device is provided which is in communication with the processor for designating each trip as either a business trip or a personal trip. The input device has at least one manual input. A sensor is in communication with the processor for determining a commencement of the trip. An alarm is in communication with the processor. The processor activates the alarm when the trip sensor senses the commencement of a trip and deactivates the alarm when the input device indicates that a selection has been made through the input device to identify the trip as a personal trip or as a business trip.

There are various business travel tracking devices that use global positioning system technology to create a record. An advantage of the present invention is that an incessant alarm forces the driver make a designation as to a personal trip or a business trip at the commencement of the trip. This contemporaneous designation is more reliable and less time consuming than a subsequent review and characterization from a created record. The resulting data provides an auditable record. In the unlikely event the alarm is ignored, the trip will be characterized as a personal trip.

There are many persons who, during the course of their day, do work that is chargeable to more than one business. Although beneficial results may be obtained through the use of a single business trip input, even more beneficial results may be obtained when the manual input of the input device is capable of designating each trip as one of a plurality of business trip categories. This allows the travel to be allocated to a particular business, particular business division or a particular client.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a travel tracking apparatus.

FIG. 2 is a perspective view of an alternative travel tracking apparatus.

FIG. 3 is a block diagram of a travel tracking apparatus.

FIG. 4 is a block diagram of an alternative travel tracking apparatus.

FIG. 5 is an example of a trip recorded by the travel tracking apparatus.

FIG. 6 is a first flow chart of the operation of a travel tracking apparatus.

FIG. 7 is a second flow chart of the operation of a travel tracking apparatus.

### DETAILED DESCRIPTION

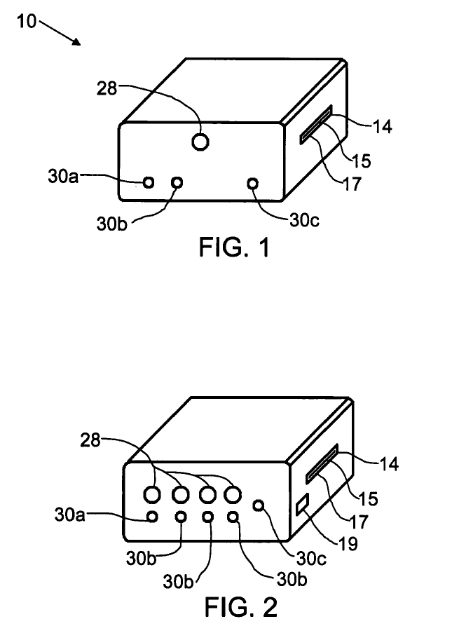

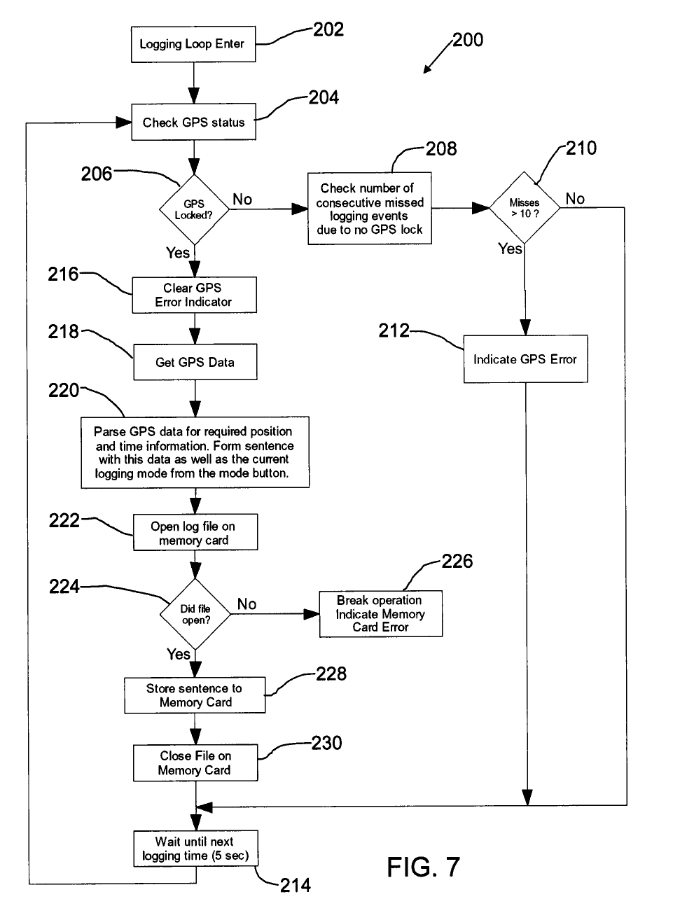

A travel tracking apparatus generally identified by reference numeral 10, will now be described with reference to FIG. 1 through 5. An example of the operation of travel tracking apparatus 10 will then be discussed with reference to FIGS. 6 and 7.

### Structure and Relationship of Parts:

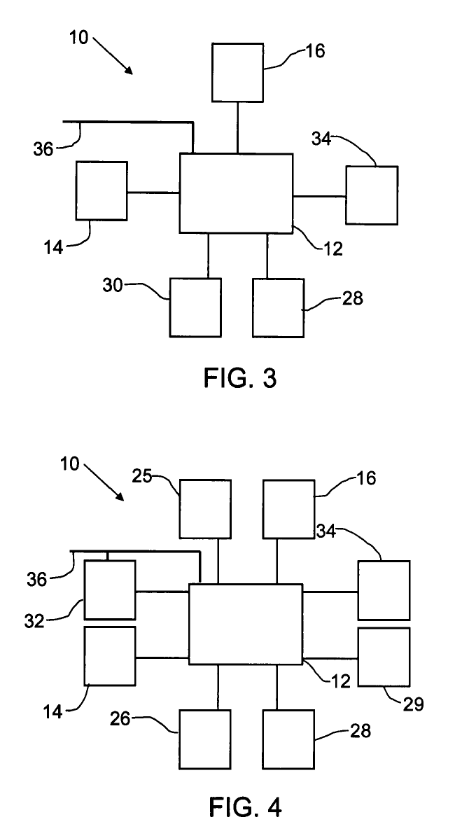

Referring to FIG. 3, travel tracking apparatus 10 includes a processor 12 having a memory device 14. Memory 14 may be a processor memory, and may take various forms as will be understood by those skilled in the art. For example, referring to FIG. 1, memory 14 may be a removable memory device 15, such as an SD card, that connects to a port 17 connected to processor 12. Alternatively, or in addition, memory device 15 may be an internal memory device, such as flash memory, that information is accessed or downloaded using known techniques. For example, referring to FIG. 2, a USB port 19 may be provided to access memory device 15. USB port 19, or a different data port, may also be provided to reprogram processor 12. If a removable memory device 15 is used, it may be possible to use memory device 15 for some processing steps, or to store software used to access the data at a later date.

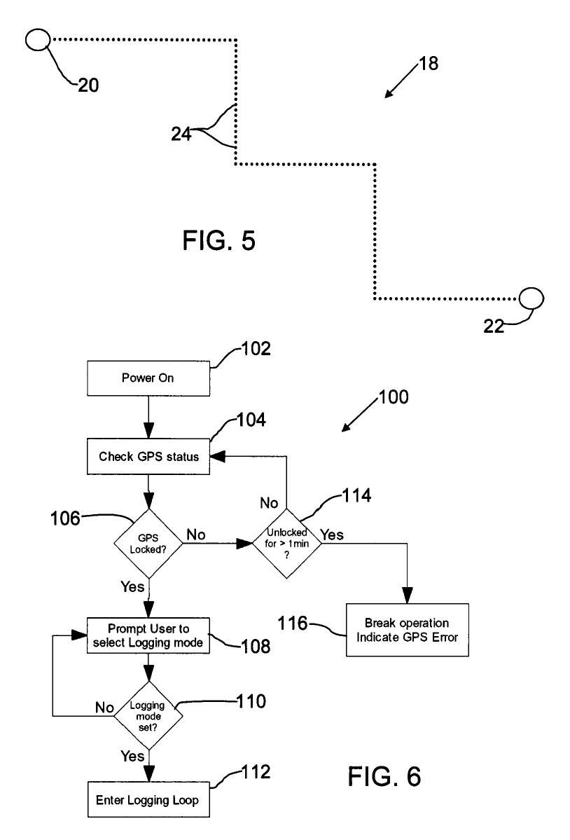

Referring to FIG. 3, a global positioning system (GPS) sensor 16 is provided for determining vehicle position. GPS sensor 16 communicates geographic location data to processor 12 to allow processor 12 to record a trip 18 shown in FIG. 5, including a starting point 20, a destination 22, and points 24 at periodic intervals along a travel route between starting point 20 and destination 22. While points 24 are shown as evenly spaced, it will be understood that the actual spacing in distance will depend upon the speed of the vehicle, assuming an evenly distributed time interval. Referring to FIG. 3, with this information, processor 12 is able to calculate mileage, with all of the foregoing being stored in processor memory 14. Processor memory 14 may also store information such as the current time and speed at each interval. Each interval will also be identified according to a particular category, such as business or personal, as discussed below. This may be contrasted with devices that merely store the GPS data as a log of position data, which is then uploaded to, for example, a web server or personal computer to process the data, including filtering the data to remove erroneous data points, and determine the mileage. The disadvantage of post processing is that it requires the mobile unit to store large amounts of data. This large amount of data limits the total amount of time the logger can be active before it is required to upload the data for processing. Post processing by a remote computer (ie a web server on the internet) becomes tedious when large amounts of data are required to be uploaded.

The present device preferably processes GPS information in real time by calculating the distance between position data points as they are received from the GPS sensor 16. This results in much less data needing to be stored to memory, and allows data to be be uploaded through the internet much quicker.

Typically, the volume of data which is required to describe a trip (start location, end location, distance traveled) is several orders of magnitude less than in a system which relies on post processing of periodically sampled GPS data. The disadvantage of real time processing is that the GPS data cannot be supplemented with outside data such as road locations. If the GPS data is inaccurate or limited due to poor satellite geometry, weather effects or multipath reception, errors in the calculated distance will appear.

While GPS sensor 16 can be used to track mileage, GPS measurements alone (usually taken once per second) can result in displacement errors as a result of noisy or limited GPS data. Poor satellite geometry, weather effects and multipath reception can result in GPS position data with large variance. This variance, or noise makes it difficult to determine the true position of a slow moving vehicle since position variance between two successive GPS measurements can exceed the actual distance which the vehicle has moved.

Referring to FIG. 4, an accelerometer 25 may be connected to processor 12 to supply acceleration data to processor 12. Accelerometer data does not suffer the same measurement noise as GPS sensor 16, and is very accurate for measuring changes in speed and distance over a short period of time. The accelerometers strong point overlaps with the GPS's weak point. Vehicle dynamics also put a bound on the type of motion we can consider to be valid. For example, there is upper limit on vehicle acceleration, and acceleration is typically in the same direction as the vehicle is traveling. This knowledge of the vehicle dynamics can be considered another data source.

By combining the data from periodic GPS measurements with acceleration data and knowledge of expected vehicle dynamics, the errors present in a GPS only system can be reduced, thus enhancing the GPS data and providing more accurate distance measurements through sensor fusion. Sensor fusion combines information from multiple noisy data sources to provide a better picture or solution than what would be available by using each data source individually.

In one embodiment, the accelerometer may be added to the printed circuit that supports the various circuit components, and the sensor fusion may be implemented using, for example, a discrete Kalman filter via software integration. Other implementation strategies will be recognized by those familiar with sensor fusion. Processing of the GPS and accelerometer data may then be accomplished in real time by processor 12.

When processing the data, it should be noted that the orientation of travel tracking apparatus 10 within the vehicle is not expected to be fixed. As the user interacts with apparatus 10, the location and orientation of may periodically change. This should be taken into account such that the implementation is able to adapt to changes in the orientation and location within the vehicle.

Referring to FIG. 1, an input device that has a manual input 28 is provided that is in communication with processor 12 that is used to designate each trip 18 as either a business trip or a personal trip by activating manual input 28. In the depicted embodiment, manual input 28 toggles between the type of trip, with the selection being identified by an LED light. In some embodiments, there may be more than one possible category of business trips or personal trips, manual input 28 would be activated until the desired selection is made. Alternatively, with reference to FIG. 2, each trip category could have its own manual input instead of a single input that toggles between trip categories. Preferably, each time a trip commences, the designation is reset, such that the selection must be made again to force the user to designate the trip category. The trip category may also be toggled at any time during operation. A message display system may also be used. In one embodiment, an output device 30, such as light indicators 30a, 30b may be provided to indicate the selected trip category, and light indicator 30c may be provided to indicate whether apparatus 10 is operating properly or not. Other indicators may be included as needed or desired. Alternatively, referring to FIG. 4, apparatus 10 may have a display screen 26 to communicate information to the user, or a microphone 29 to record information from the user. In a further embodiment, display screen 26 may be a touch screen, such that it also acts as manual input 28.

Referring to FIG. 4, a sensor 32 is in communication with processor 12 to determine when trip 18 commences. For example, sensor 32 may be a processor 12 connected via a power cord 36 to the 12 V power supply common in most cars (not shown) that turns on when the vehicle is turned on. The first reading taken by GPS sensor 16 indicates the starting point, and indicates the start of the trip. The processor may consider the trip to have commenced even if the engine is not on. Similarly, when the vehicle is turned off and the power supply is cut, the last reading taken by GPS sensor 16 marks the end point of the trip. Other sensors, such using accelerometer 25 to detect an initial movement, or the GPS detecting a change in position, may also be used as will be recognized by those skilled in the art. For example, in vehicles where the power to apparatus 10 is always on (for example connected directly to the vehicle battery, or powered by its own power source), it is desirable to enter a low power mode when it has been detected that the vehicle has been stationary for an extended period of time. Since GPS sensor 16 uses the majority of the power, it is necessary to shut off GPS sensor 16 to achieve this low power mode. The problem then becomes how to detect when the vehicle again starts to move if GPS sensor 16 is off. Turning on GPS sensor 16 every few minutes to check for movement may result in lost data if the vehicle starts moving while GPS sensor 16 is off. Accelerometer 25 provides a better solution for determining when the vehicle has started moving since it consumes very little power compared to GPS sensor 16 and can therefore be left on when in sleep mode. Once movement has been detected, and GPS sensor 16 has been turned on, accelerometer 25 can also provide distance measuring capability for the first 20-30 seconds until GPS sensor 16 gets full satellite reception.

There is an alarm 34 in communication with processor 12. Processor 12 activates alarm 34 when trip sensor 32 senses the commencement of a trip, and deactivates alarm 34 when input device 26 indicates that a selection has been made through either personal trip input 28 to identify the trip as a personal trip, or through business trip input 30 to identify the trip as a business trip.

In some circumstances, a user will be concerned with the amount of personal travel, for example, an employer or manager determining how much of a taxable benefit to attribute to an employee with use of a company vehicle. In other circumstances, a user will be concerned with the amount of business travel, for example, an individual claiming a deduction for business use of a personal vehicle. Thus, in some embodiments, the device may be configured to only track business or personal trips. In other embodiments privacy concerns may make it necessary to black out the details of personal trips, or simply not record the actual positions, such that only the total mileage is reported or recorded.

### Operation:

An example of the operation of apparatus 10 described above will now be discussed with reference to FIG. 6 and FIG. 7. This example uses only GPS sensor 16, and not accelerometer 25, shown in FIG. 4. It will be understood that appropriate modifications may be made if accelerometer 25 is also included, as discusse above. This includes using accelerometer 25 to detect movement, help verify data from GPS sensor 16, etc.

Referring to FIG. 6, the process 100 starts when apparatus 10 is powered on in step 102. This performs the function of sensing when the trip begins. In other embodiments, the beginning of the trip could also begin, for example, when movement is sensed, or when GPS sensor 16 records a change in position. In step 104, the status of GPS sensor 16 is detected. If GPS sensor 16 is locked in decision step 104, process 100 moves on to step 108, where the user is prompted by alarm 34 to select the logging mode using manual input 28. Once the decision step 110 is satisfied that the logging mode has been set, step 112 moves the process to the logging loop 200 shown in FIG. 7. If GPS sensor 16 is not locked, and remains unlocked for over 1 minute, for example, in step 114, the process ends, and an error in GPS sensor 16 is indicated in step 116, such as by using indicator light 30c.

Referring to FIG. 7, logging loop 200 is entered at step 202. The status of GPS sensor 16 is checked in step 204 to ensure it is working properly. If GPS sensor 16 is not locked, steps 206, 208 and 210 indicate a GPS error in step 212, and once the next logging time arrives in step 214, logging loop 200 returns to step 204 to check the status. If step 206 determines the GPS is locked, step 216 clears the GPS error indicator, and step 218 acquires the GPS data which is then parsed in step 220 to obtain the required position and time information. A “sentence” is formed with this data as well as the current logging mode selected in step 110 in process 100. The log file in memory unit 14 is opened in step 222. If the log file does not open in decision step 224, the operation is broken in step 226, and a memory card error is indicated in step 226. If the log file does open, the sentence is stored in the log file in step 228, and the file is again closed in step 230.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A travel tracking apparatus, comprising:
a global positioning system sensor for sensing vehicle position data;
a processor connected to receive the vehicle position data from the global positioning system sensor, the processor being programmed to calculate a trip comprising a starting point, points at periodic intervals along a travel route, a destination, and mileage based on the vehicle position data;
a memory device connected to the processor for storing data from the trip;
an input device in communication with the processor having at least one manual input for designating each trip as either a business trip or a personal trip;
a trip sensor in communication with the processor for determining a commencement of the trip;
an alarm in communication with the processor, the processor activating the alarm when the trip sensor senses the commencement of a trip and deactivating the alarm when the input device indicates that a selection has been made through the input device;
the processor processing the information from at least one of the business trip and the personal trip.

2. The travel tracking apparatus of claim 1, wherein the at least one manual input designates each business trip as one of a plurality of business trip categories.

3. The travel tracking apparatus of claim 1, wherein the processor processes information from both the business trip and the personal trip.

4. The travel tracking apparatus of claim 1, wherein the location of the periodic intervals from the personal trip are not stored in the processor memory.

5. The travel tracking apparatus of claim 1, further comprising an accelerometer connected to the processor, the accelerometer communicating acceleration data to the processor, the processor calculating the trip based on the vehicle position data from the global positioning sensor and the acceleration data from the accelerometer.

6. The travel tracking apparatus of claim 5, wherein the processor is programmed to apply vehicle dynamics to the vehicle position data and the acceleration data.

7. The travel tracking apparatus of claim 1, wherein the memory device is a processor memory in the processor.
